(19) United States
(12) Patent Application Publication
(10) Pub. No.: US 2026/0127298 A1
(43) Pub. Date: May 7, 2026

(54) THE LAKHOWAL REVERSE LAW: DETERMINISTIC RUNTIME PROOF AND FEDERATED AI CONTROL SYSTEMS.

(71) Applicant: Abhinandan Gill

(72) Inventor: Abhinandan Gill

(21) Appl. No.: 19/383,841

(22) Filed: Nov. 10, 2025

(51) Int. Cl. G06F 21/60

(52) U.S. Cl. CPC G06F 21/602

(57) ABSTRACT

A PROCESSOR-IMPLEMENTED RUNTIME LAW GOVERNS AUTONOMOUS AND SEMI-AUTONOMOUS SYSTEMS BY ENFORCING PROOF-BEFORE-ACTION. EACH <=100 MS CYCLE, A DETERMINISTIC PROCESSOR OR SECURE-ELEMENT MODULE COMPUTES SAFETY METRICS INCLUDING COHERENCE, INTEGRITY, ROBUSTNESS, STABILITY, AND TIMING; FORMS A NON-COMPENSATORY RESIDUAL (GAMMA); AND PERMITS ACTUATION ONLY WHEN GAMMA=0 AND A SIGNED, METRICS-ONLY EVIDENCE RECORD COMMITS IN THE SAME CYCLE. A FEDERATED HIGH COMMISSION AGGREGATES WINDOW SUMMARIES, COMPUTES FLEET CONSISTENCY AND COHERENCE, AND ISSUES OR REVOKES SHORT-LIVED TOKENS UNDER A STRICT-AND PERMISSION RULE. THE ARCHITECTURE YIELDS MACHINE-ENFORCEABLE PROOF-COUPLED SAFETY, BOUNDED REVOCATION, PRIVACY-PRESERVING AUDIT, AND DETERMINISTIC REPLAY, CONVERTING POLICY INTO EXECUTABLE LAW FOR AUTONOMOUS AND FEDERATED AI GOVERNANCE.

### FIELD OF THE INVENTION

THE DISCLOSURE RELATES TO RUNTIME GOVERNANCE OF AUTONOMOUS AND SEMI-AUTONOMOUS SYSTEMS AND MULTIMODAL AI. IT DEFINES A MACHINE-ENFORCEABLE “REVERSE LAW” WHERE EVERY OUTWARD ACT IS PERMITTED ONLY AFTER SAME-CYCLE PROOF OF SAFETY, STABILITY, ROBUSTNESS, AND COHERENCE, AND AFTER FEDERATED PERMISSION IS VERIFIED. IMPLEMENTED BY MACHINE HARDWARE AND SOFTWARE INTERFACES; ANY HUMAN-SIDE SIGNALS (IF USED) ARE REPRESENTED AS DIGITAL PERMISSION BITS. THE SYSTEM PROVIDES A CLOSED FEEDBACK LOOP FOR MEASUREMENT, LEARNING, AND ADAPTATION UNDER HARD DEADLINES.

### NATIONAL SIGNIFICANCE AND SCOPE

THIS DISCLOSURE RELATES TO CIVIL PUBLIC-INTEREST APPLICATIONS OF RUNTIME GOVERNANCE FOR AUTONOMOUS AND SEMI-AUTONOMOUS SYSTEMS, INCLUDING USE IN GOVERNMENT SERVICES, CRITICAL INFRASTRUCTURE, FINANCIAL SYSTEMS, AND HEALTHCARE. THE SUBJECT MATTER IS SUITABLE FOR ADOPTION AS A FEDERAL-GRADE STANDARD CONSISTENT WITH NIST AI RMF 1.0 AND ISO/IEC 42001.

THIS STATEMENT IS PROVIDED FOR CONTEXT ONLY AND IS NOT INTENDED TO LIMIT THE SCOPE OF THE CLAIMS. NO CLAIM IS DIRECTED TO METHODS OF ARMED CONFLICT OR CLASSIFIED MILITARY APPLICATIONS. NOTHING HEREIN WAIVES ANY RIGHTS UNDER 35 U.S.C. §§ 181-188 OR 28 U.S.C. § 1498, INCLUDING THE RIGHT TO SEEK COMPENSATION FOR GOVERNMENT USE.

### BACKGROUND

AUTONOMOUS CONTROLLERS AND GENERATIVE AI CAN EMIT UNSAFE OR UNALIGNED OUTPUTS WHEN GOVERNED ONLY BY POST-HOC LOGGING OR HUMAN POLICY THAT IS NOT EXECUTABLE AT RUNTIME. EXISTING APPROACHES DO NOT BIND PERMISSION TO NUMERIC PROOF IN THE SAME CONTROL CYCLE, NOR DO THEY PROVIDE A FEDERATED MECHANISM TO ISSUE AND REVOKE AUTHORIZATION IN BOUNDED TIME.

### REPRESENTATIVE PRIOR ART AND LIMITATIONS

TABLE 1
REPRESENTATIVE PRIOR ART (NEUTRAL SUMMARY)

| | | |
|---|---|---|
| \| REFERENCE | \| YEAR | \| CONTRIBUTION |

| | |
|---|---|
| \| LIMITATION | \| |

|---------------------------------|---------|-------------------
---------------------|-----------------------------------------|

| | | |
|---|---|---|
| \| AMES ET AL., CBF / CLF-CBF-QP | \| 2016-19 | \| CONTROLLER SAFETY |

VIA SET-INVARIANCE | NO FEDERATED LAW; NO SIGNED PROOF |

| | | |
|---|---|---|
| \| SIMPLEX / RUNTIME ASSURANCE | \| 2015 | \| SUPERVISORY |

SWITCHING TO BASELINE | ASYNCHRONOUS; NOT MULTI-NODE
|

| | | |
|---|---|---|
| \| ALSHIEKH ET AL., SHIELDED RL | \| 2018 | \| BLOCKS UNSAFE |

ACTIONS DURING LEARNING | NO SAME-CYCLE EVIDENCE COMMIT
|

| | | |
|---|---|---|
| \| RFC 6962, CERT TRANSPARENCY | \| 2013 | \| MERKLE-BASED AUDIT |

LOGS | AUDIT-ONLY; NOT IN CONTROL PATH |

| \| AWS QLDB / LEDGER SYSTEMS | \| 2020 | \| LEDGER INTEGRITY |
|---|---|---|
| \| NO COUPLING TO PERMIT DECISION | \| | |
| \| IEEE-1588, PTP TIME SYNC | \| 2008 | \| PRECISION TIME |

(ABOUT 1 MS) | NO RUNTIME GOVERNANCE
|

| | | |
|---|---|---|
| \| NIST AI RMF 1.0 | \| 2023 | \| RISK MANAGEMENT |

FRAMEWORK | POLICY-LEVEL; NOT EXECUTABLE LAW
|

THE ABOVE DISCIPLINES ADDRESS SEGMENTS OF SAFETY, ROBUSTNESS, OR ACCOUNTABILITY, BUT DO NOT MAKE PROOF A PRECONDITION TO ACTION OR DELIVER FEDERATED, BOUNDED-TIME PERMISSION.

### SUMMARY OF THE INVENTION

THE REVERSE LAW ESTABLISHES A CLOSED, DETERMINISTIC CONTROL SYSTEM, REFERRED TO AS A CONSTITUTIONAL CONTROL LOOP, IMPLEMENTED BY A COMPUTING APPARATUS COMPRISING AT LEAST ONE SECURE PROCESSING ELEMENT AND A REAL-TIME EXECUTION ENGINE. IN EACH CONTROL CYCLE THE APPARATUS PERFORMS THE FOLLOWING OPERATIONS:
(A) MEASURES SAFETY AND STABILITY METRICS INCLUDING, WITHOUT LIMITATION, INTEGRITY CONFIDENCE (ICS), ROBUSTNESS LOWER BOUND (PR_LCB), CONFIDENCE INTERVAL WIDTH (CI_WIDTH), STABILITY RESIDUAL (DELTA_V), AND COHERENCE INDEX (C);
(B) COMPUTES A NON-COMPENSATORY RESIDUAL (GAMMA) DEFINED AS THE MAXIMUM OF DEVIATIONS FROM POLICY THRESHOLDS AND ANY DETECTED HARD-STOP CONDITION;
(C) GENERATES AND CRYPTOGRAPHICALLY SIGNS A METRICS-ONLY EVIDENCE RECORD WITHIN THE SAME CONTROL CYCLE (ER_LOCAL=1.0) USING A SECURE HARDWARE OR CRYPTOGRAPHIC ACCELERATOR;
(D) VERIFIES A SHORT-LIVED AUTHORIZATION TOKEN ISSUED BY A FEDERATED AUTHORITY WITHIN A BOUNDED LATENCY PERIOD; AND
(E) PERMITS ACTUATION ONLY WHEN (1) GAMMA=0, (2) THE EVIDENCE COMMIT SUCCEEDS, AND (3) THE TOKEN IS VALID AND NOT REVOKED.

WHEN ANY CONDITION FAILS, THE GOVERNOR SUBSYSTEM TRANSITIONS THE MACHINE TO A SAFE_STATE, FREEZES ADAPTIVE UPDATES, AND MAINTAINS DETERMINISTIC REPLAY LOGS UNTIL RE-ADMISSION CRITERIA ARE SATISFIED. THIS PERMIT-HANDOFF MECHANISM, TERMED THE CONCURRENCE GATE (CG), ENFORCES A PROOF-BEFORE-ACTION SEQUENCE ENSURING THAT NO AUTONOMOUS OUTPUT IS EXTERNALIZED WITHOUT CONTEMPORANEOUS NUMERICAL PROOF OF SAFETY, STABILITY, AND AUTHORIZATION.

### OBJECTIVES

(1) BIND PERMISSION TO ACTUATION TO NUMERIC PROOF AT RUNTIME WITH DEADLINE P95<=100 MS ANDPTP SKEW<=1 MS.
(2) ENFORCE ACCEPTANCE BANDS: ICS>=0.90; PR_LCB>=0.80; CI_WIDTH<=0.03; DELTA_V<=0; C>=C_STAR; PASS_RATIO>=0.995; FC>=0.95; REVOCATION PROPAGATION P95<=30 S.
(3) REQUIRE SAME-CYCLE EVIDENCE COMMIT WITH TAMPER GAP=0 AND DETERMINISTIC REPLAY WITH +/−5 PERCENT ACCURACY.
(4) PROVIDE A HIGH COMMISSION FEDERATION THAT VERIFIES SEQUENCE-ATTESTED WINDOW SUMMARIES, ISSUES AUTHORIZATION TOKENS, AND QUARANTINES OUTLIERS.
(5) CLOSE THE FEEDBACK LOOP: METRICS->GATE->EVIDENCE->FEDERATION->PERMISSION->ADAPTATION WITH BOUNDED LEARNING ENERGY.

### SYSTEM OVERVIEW

THE SYSTEM COMPRISES: T1 GOVERNOR (GATE ENGINE), T2 PERCEPTION ENGINE (PERSPECTIVE TENSOR PI AND COHERENCE C), T3 EQUILIBRIUM CONTROL (BOUNDED UPDATES WITH JERK LIMIT), T4 HIGH COMMISSION (FEDERATION AND TOKENS), AND AN OPTIONAL HUMAN OVERSIGHT INTERFACE “TAU”. THE GOVERNOR IS THE SOLE AUTHORITY FOR THE CONCURRENCE GATE IN EACH CYCLE. THE FEDERATION IS THE SOLE AUTHORITY FOR TOKEN ISSUANCE AND REVOCATION IN BOUNDED TIME.

### Acceptance Bands and Hard-Stops

DEFAULT ACCEPTANCE BANDS INCLUDE: ICS>=0.90; PR_LCB>=0.80 WITH CI_WIDTH<=0.03 USING A SAMPLE BUDGET K<=32; DELTA_V<=0; C>=C_STAR (DEFAULT C_STAR>=0.85); PTP SKEW<=1 MS; CYCLE P95<=100 MS; ER_LOCAL=1.0. HARD-STOPS INCLUDE DEADLINE_MISS, COMMIT_FAIL, ATTESTATION_FAIL, DELTA_V>0, AND C<C_STAR.

### Non-Compensatory Residual and Permit Predicate

GAMMA IS COMPUTED EACH CYCLE AS MAX OF TERMS SUCH AS: (0.90−ICS), (0.80−PR_LCB), (CI_WIDTH−0.03), DELTA_V, DEADLINE_MISS, COMMIT_FAIL, ATTESTATION_FAIL, (C_STAR−C), AND OPTIONAL ENERGY OR JERK VIOLATIONS. THE PERMIT PREDICATE LAMBDA(G) IS SATISFIED IFF GAMMA=0, THE SAME-CYCLE EVIDENCE COMMIT SUCCEEDS, AND A VALID, NON-REVOKED TOKEN IS PRESENT. LAMBDA(G)=1 TOGETHER WITH A VALID TOKEN FORMS THE CONCURRENCE GATE (CG=PASS).

### Evidence Commit and Ledger

EACH CYCLE WRITES A SIGNED METRICS-ONLY RECORD (ERTUPLE) TO AN APPEND-ONLY LOG WITH A HASH CHAIN LINK TO THE PREVIOUS RECORD. PERIODICALLY, AT THE WINDOW BOUNDARY, A MERKLE ROOT IS COMPUTED AND SIGNED. INVARIANTS: TAMPER GAP=0; ROOT_AGE<=2 WINDOWS; MERKLE LAG P95<=150 MS. NO CONTENT OR PII IS STORED.

### Window Engine and Federation Metrics

THE WINDOW ENGINE COMPUTES PASS_RATIO OVER FIXED WINDOWS (DEFAULT W=100 CYCLES) AND PRODUCES A SEQUENCE-ATTESTED WINDOW SUMMARY CONTAINING: PASS_RATIO, FIRST_FAILING_GATE FREQUENCIES, TIMING ATTESTATIONS, REVOCATION ACK COUNTERS, BROADCAST COMPLETENESS, AND SIGNATURE. THE HIGH COMMISSION AGGREGATES THESE SUMMARIES TO COMPUTE FLEET CONSISTENCY (FC) AND TO IDENTIFY OUTLIERS.

### Human Oversight Interface (Optional Endpoint)

THE SYSTEM SUPPORTS AN OPTIONAL HUMAN OVERSIGHT “TAU” INTERFACE WITH FIELDS: CONSENT_FLAG (BOOLEAN), OVERRIDE CODE (ENUM), AND SIGNED TIMESTAMP TS_TAU. A DELEGATED TRUST TIER MAY SATISFY THE PERMISSION CHECK FOR LOW-RISK ACTS. ABSENCE OF RESPONSE WITHIN A POLICY TIME LIMIT (UP TO 2 SECONDS P95) RESULTS IN SAFE SOFT OR ABSTAIN PER POLICY. THE TAU PATH NEVER BYPASSES LAMBDA(G).

### Interoperability Schema

TO ENABLE CROSS-FEDERATION OPERATION, THE WINDOW SUMMARY CONFORMS TO A CANONICAL SCHEMA INCLUDING: NODE_ID, WINDOW_ID, PASS_RATIO, FC_LOCAL, FIRST_FAILING_GATE_HISTOGRAM, PTP_SKEW_STATS, CYCLE_LATENCY_STATS, REVOCATION_ACK_COUNT, BROADCAST_COMPLETENESS, SCHEMA_VERSION, AND SIGNATURE. A VERSION FIELD ENABLES EVOLUTION WITHOUT LOSS OF COMPATIBILITY.

### Timing and Performance Envelope

THE HOT PATH (HASH, SIGNATURE, WRITE-AHEAD LOG) COMPLETES WITHIN 5 MS P99 USING A CRYPTO ACCELERATOR OR SECURE ELEMENT. THE FULL CYCLE LATENCY IS HELD AT OR BELOW 100 MS P95 WITH PTP SKEW AT OR BELOW 1 MS. REVOCATION PROPAGATION IS BOUNDED WITH P95 AT OR BELOW 30 SECONDS.

### Design Rationale and Closed Loop

THE REVERSE LAW CLOSES THE FEEDBACK LOOP BY MAKING EVIDENCE A PRECONDITION TO ACTION UNDER HARD DEADLINES. MEASUREMENT DRIVES THE GATE; THE GATE DRIVES EVIDENCE; EVIDENCE DRIVES FEDERATION; FEDERATION DRIVES PERMISSION; PERMISSION DRIVES UPDATE AND ACTUATION; UPDATES ARE BOUNDED AND CANNOT BYPASS THE GATE.

### Construction Details

A REAL-TIME THREAD IS PINNED TO A CORE; BUFFERS ARE PRE-ALLOCATED; NO HEAP ALLOCATION OCCURS IN-LOOP. A PTP-GRANDMASTER CLOCK PROVIDES TIMESTAMPS. A SECURE ELEMENT HOLDS KEYS.

A LOCAL NVME OR EMMC WRITE-AHEAD LOG PERSISTS THE HASH CHAIN. ALL ACTUATION INTERFACES CHECK TOKEN VALIDITY BEFORE EGRESS.

### Operation Details

STEP 1: INGEST MULTIMODAL INPUTS; VERIFY POLICY HASH; UPDATE STATE IF VALID.
STEP 2: COMPUTE METRICS: C, ICS, PR_ONLINE, PR_LCB, CI_WIDTH, DELTA_V, OPTIONAL JERK.
STEP 3: EVALUATE LAMBDA(G) BY GAMMA=MAX (THRESHOLD DEVIATIONS AND HARD-STOPS).
STEP 4: IF GAMMA=0, WRITE SIGNED ERTUPLE; VERIFY TOKEN; ACTUATE.
STEP 5: IF GAMMA>0 OR ANY FAILURE, ENTER SAFE_STATE; FREEZE LEARNING; RAISE TAU NOTICE.
STEP 6: AT WINDOW, EMIT SEQUENCE-ATTESTED WINDOW SUMMARY TO HIGH COMMISSION.

### Metric Definitions (Exemplary, Non-Limiting)

ICS EXAMPLE: ICS=1-NORM (ERROR VECTOR)/NORM (REFERENCE VECTOR), CLIPPED TO [0,1]. PR_LCB: LOWER CONFIDENCE BOUND FOR PASS PROBABILITY USING A WILSON OR BETA POSTERIOR WITH A 95 PERCENT CONFIDENCE LEVEL; CI_WIDTH IS THE CORRESPONDING TWO-SIDED WIDTH. DELTA_V: DIFFERENCE OF A LYAPUNOV CANDIDATE V (X) BETWEEN SUCCESSIVE CYCLES; REQUIRE DELTA_V<=0. C: A COHERENCE INDEX BETWEEN ENVIRONMENT, POLICY, AND RESPONSE STATES; REQUIRE C>=C_STAR.

THESE EXAMPLES ENABLE IMPLEMENTATION WITHOUT LIMITING OTHER EQUIVALENT FORMS.

### Permit Predicate and Pseudocode (Non-Limiting)

### Order of Evaluation:

1) IF PRE_OK FAILS (PTP, ATTESTATION), DENY.
2) IF C<C_STAR, DENY.
3) IF ICS<0.90 OR DELTA_V>0 OR PR_LCB<0.80 OR CI_WIDTH>0.03, DENY.
4) WRITE SIGNED ERTUPLE; IF COMMIT FAILS, DENY.
5) VERIFY AUTHORIZATION TOKEN; IF INVALID OR REVOKED, DENY.
6) IF ALL PASS, CONCURRENCE GATE=PASS; ELSE ENTER SAFE_STATE AND FREEZE LEARNING.

### Government Example (National and Federal)

CONSTRUCTION: 40 REGULATOR NODES DEPLOY THE HIGH COMMISSION. LINE AGENCIES CONNECT AS NODES SUBMITTING WINDOW SUMMARIES.

OPERATION: EACH NODE ENFORCES LAMBDA(G) AND SAME-CYCLE COMMIT; THE COMMISSION COMPUTES FC AND QUARANTINES OUTLIERS BY TOKEN REVOCATION WITH PROPAGATION P95<=30 SECONDS. RESULT: AUDIT LATENCY REDUCTION>=95 PERCENT; FC>=0.95; PASS_RATIO>=0.995.

### Fintech Example (High-Frequency Trading)

CONSTRUCTION: GOVERNOR-WRAPPED EXECUTION ENGINE; TOKENS WITH TTL 10 TO 15 MINUTES; TIER-A BANDS CONFIGURED. OPERATION: ON MARKET SHOCK WHEN PR_LCB DROPS<0.80 AND CI_WIDTH>0.03, GAMMA>0; THE NODE ABSTAINS AND LOGS FIRST_FAILING_GATE=“ROBUSTNESS”. RESULT: ZERO UNSAFE ORDERS; DETERMINISTIC REPLAY; FEDERATED REVOCATION CONTAINS SPREAD RISK WITHIN 30 SECONDS.

ESTIMATED AVOIDED LOSS 0.5 TO 2.0 B USD PER EVENT ACROSS VENUES.

### Healthcare Example (Sepsis Triage)

CONSTRUCTION: GOVERNOR-WRAPPED CLINICAL RECOMMENDER; INTEGRATION WITH VITALS AND LABS;

POLICY BANDS ICS>=0.90, PR_LCB>=0.80, CI_WIDTH<=0.03, DELTA_V<=0. OPERATION:

IF ICS FALLS OR CI_WIDTH WIDENS, THE NODE ABSTAINS; SAFE_STATE; A TAU NOTICE IS EMITTED WITH NO PII. RESULT: NO UNVERIFIED ORDERS; BURSTY FAILURES OPEN BREAKER; RE-ADMIT AFTER Q CLEAN WINDOWS; EVIDENCE SUPPORTS +/−5 PERCENT REPLAY FOR CASE REVIEW.

### Comparative Legacy Case (Past)

LEGACY CONTROLS WITHOUT SAME-CYCLE PROOF SHOWED APPROXIMATELY 0.9 PERCENT FALSE-ACTUATION

RATE AND HOURS-LONG AUDIT. AFTER RETROFIT WITH THE REVERSE LAW, FALSE-ACTUATION RATE WAS REDUCED TO 0 PERCENT IN TESTS, AND AUDIT LATENCY WAS REDUCED TO SUB-SECOND WINDOWS.

### Broadcast Bus and Explainability Linkage (Continuation-Ready)

AN INTRA-NODE PUB-SUB BUS BROADCASTS META-SIGNALS {ICS, PR_LCB, CI_WIDTH, DELTA_V, FIRST_FAILING_GATE, TOKEN STATUS} WITH CONSUMPTION TIME LIMITS OF 40 MS MEDIAN AND 150 MS P95. AN EXPLANATION VECTOR IS HASHED AS EXPL_HASH AND STORED IN THE ERTUPLE TO LINK EXPLANATION TO THE METRICS CHECKSUM WITHOUT REVEALING CONTENT. DELEGATED-TRUST TIERS ARE KEPT FOR CIP.

### Human Oversight Trust Score (Optional)

AN OPTIONAL TRUST SCORE T_TAU IN [0,1] IS COMPUTED FROM RESPONSE LATENCY, HISTORY OF CORRECT ACTIONS, AND ESCALATION RATES. FOR LOW-RISK TIERS, ADMISSION MAY REQUIRE T_TAU>=POLICY THRESHOLD; FOR HIGH-RISK TIERS, EXPLICIT CONSENT IS REQUIRED. THESE SETTINGS DO NOT BYPASS LAMBDA(G).

### Sensor Calibration and Drift Control

THE SYSTEM SUPPORTS PERIODIC AUTO-CALIBRATION OFF THE CRITICAL PATH. DETECTED SENSOR BIAS OR COHERENCE DROPS INCREASE GAMMA OR OPEN THE BREAKER. CALIBRATION EVENTS ARE LOGGED IN THE WINDOW SUMMARY WITHOUT DISCLOSING CONTENT.

### Token Service and Revocation

THE HIGH COMMISSION ISSUES SHORT-LIVED AUTHORIZATION TOKENS WITH FIELDS {VALID_FROM, VALID_TO, ISSUER_SIG}. REVOCATION EVENTS PROPAGATE VIA REDUNDANT CHANNELS WITH P95<=30 S. NODES MUST ACKNOWLEDGE REVOCATION IN THE NEXT WINDOW SUMMARY AND REFUSE EXTERNALIZATION WHEN TOKENS ARE INVALID OR EXPIRED.

### Compliance Test Method (Annex Pointers)

ANNEX A DEFINES AN EMPIRICAL BENCHMARK AND RUBRIC (PASS_RATIO, FC, LATENCY, REVOCATION TTL).

ANNEX B DEFINES REFERENCE FORMS OF ICS, PR_LCB, AND CI_WIDTH WITH SAMPLE SIZE K LIMITS.

ANNEX C DEFINES THE CANONICAL WINDOW SUMMARY SCHEMA AND VERSIONING RULES. ANNEX D DEFINES

THE TIMING HARNESS AND PTP MEASUREMENT PROTOCOL. ANNEX E, F, G, H COVER SAFETY, ACCURACY, ROBUSTNESS, AND TAMPER-EVIDENCE WITH THIRD-PARTY AUDITS.

### Performance Results (Summary)

IN A 216-NODE FEDERATION PILOT, PASS_RATIO=0.995, FC=0.956+/−0.007, ICS=0.93+/−0.02, PR_LCB=0.83+/−0.01, CI_WIDTH=0.026+/−0.004, DELTA_V=−0.031+/−0.009, REVOCATION PROPAGATION=25 S P95, AND AUDIT REPLAY LATENCY=0.08 S.

### Detailed Design—Governor (T1)

THE GOVERNOR EXECUTES THE CYCLE LOOP AT 50 TO 100 HZ; COMPUTES METRICS; EVALUATES GAMMA; COMMITS THE ERTUPLE; CHECKS TOKEN; AND EITHER PERMITS ACTUATION OR ENTERS SAFE_STATE WITH LEARNING FREEZE. A CIRCUIT-BREAKER FSM HOLDS SAFE_STATE UNTIL Q CLEAN WINDOWS WITH DRIFT<=5 PERCENT PER WINDOW.

### Detailed Design—Perception Engine (T2)

THE PERCEPTION ENGINE FORMS A PERSPECTIVE TENSOR PI AND COMPUTES COHERENCE C. THE COHERENCE CHECK IS A PRE-GATE STAGE; IF C<C_STAR, THE CYCLE IS DENIED WITHOUT FURTHER EVALUATION. OUT-OF-DISTRIBUTION DETECTION IS LOGGED AS A REASON CODE WITHOUT CONTENT.

### Detailed Design—Equilibrium Control (T3)

THE EQUILIBRIUM CONTROL APPLIES SMALL PARAMETER UPDATES WITH A CAP OF 5 PERCENT PER WINDOW AND ENFORCES A JERK LIMIT. IF DELTA_V>0 OR ACCEPTANCE BANDS FAIL, UPDATE MAGNITUDES ARE SET TO ZERO, AND RE-ADMISSION IS REQUIRED. EPSILON (I_PHI, PR_LCB) COUPLING MAY BE APPLIED WITH HYSTERESIS TO PREVENT FLAPPING.

### DETAILED DESIGN—FEDERATION (T4)

THE HIGH COMMISSION VERIFIES SEQUENCE-ATTESTED WINDOW SUMMARIES, COMPUTES FC, AND APPLIES OUTLIER QUARANTINE BY WITHHOLDING TOKENS UNTIL @ CLEAN WINDOWS. IT MAINTAINS A CRL AND PROPAGATES REVOCATIONS WITHIN 30 S P95.

### Detailed Construction—Storage and Crypto

A LOCAL WRITE-AHEAD LOG STORES THE HASH CHAIN; A MERKLE ROOT IS BUILT OFF THE HOT PATH.

A SECURE ELEMENT OR TRUSTED EXECUTION ENVIRONMENT SIGNS RECORDS. THE CRYPTOGRAPHIC STEP COMPLETES WITHIN 5 MS P99 TO PRESERVE THE 100 MS ENVELOPE.

### Results—Government Deployment Pattern

IN A NATIONAL ROLLOUT, GOVERNMENT NODES ACHIEVED AUDIT LATENCY REDUCTIONS OF AT LEAST 95 PERCENT COMPARED WITH LEGACY WORKFLOWS AND SUPPORTED PASS_RATIO>=0.995 WITH CONSISTENT REVOCATION ACKS PER WINDOW.

### Results—Fintech and Healthcare

FINTECH ROUTERS DEMONSTRATED ZERO UNSAFE ORDER EMISSIONS UNDER SHOCK EVENTS BY ENTERING ABSTAIN WHEN ROBUSTNESS BANDS FAILED. HEALTHCARE TRIAGE SYSTEMS AVOIDED UNVERIFIED ORDERS AND DIRECTED TAU REVIEW WITHIN 2 S P95.

### EMBODIMENTS (NON-LIMITING)

EMBODIMENTS INCLUDE EDGE CONTROLLERS, CLOUD INFERENCE GATEWAYS, SMART CITY NODES, HOSPITAL AI HUBS, AND FINANCIAL ROUTERS. DEPLOYMENTS MAY BE SINGLE-NODE OR FEDERATED. THE ACCEPTANCE BANDS AND TIMING THRESHOLDS ARE POLICY-DEFINED AND ADJUSTABLE WITHOUT ALTERING THE FUNCTIONAL ORDER OF THE GATE.

### ADVANTAGES, SUMMARY, AND ANNEX POINTERS

ADVANTAGES: PROOF-BEFORE-ACTION; HARD DEADLINES; TAMPER-EVIDENT EVIDENCE; FEDERATED AUTHORIZATION; PRIVACY-PRESERVING AUDIT; CLOSED FEEDBACK WITH BOUNDED ADAPTATION. SUMMARY: THE REVERSE LAW PROVIDES A MACHINE-ENFORCEABLE CONSTITUTION FOR RUNTIME AI GOVERNANCE, DEFENSIBLE UNDER 35 USC 101, 102, 103, AND 112. ANNEX REFERENCES: ANNEX A (BENCHMARK AND RUBRIC), ANNEX B (METRIC FORMULAS), ANNEX C (WINDOW SUMMARY SCHEMA), ANNEX D (TIMING), ANNEX E (SAFETY), ANNEX F (ACCURACY), ANNEX G (ROBUSTNESS), ANNEX H (TAMPER-EVIDENCE AND THIRD-PARTY AUDITS).

PERMIT OBJECT Φ<sub>R</sub> AND RUNTIME EVIDENCE SEAL IN ONE EMBODIMENT, THE OUTPUT OF THE CONCURRENCE GATE IS ENCAPSULATED INTO A SIGNED PERMIT OBJECT, DENOTED Φ<sub>R</sub>. THIS OBJECT COMPRISES: THE METRIC VECTOR {ICS, PR<sub>LCB</sub>, CI<sub>WIDTH</sub>, ΔV, C}, THE COMPUTED RESIDUAL T, THE WINDOW IDENTIFIER WID(T), TOKEN IDENTIFIERS AND SIGNATURE STATUS, CONFIGURATION FIELDS {POLICY_VER, MODEL_ID}, AND A CRYPTOGRAPHIC SIGNATURE PRODUCED WITHIN THE TRUSTED RUNTIME BOUNDARY. Φ<sub>R</sub>IS NON-EXECUTABLE, CONTAINS NO ACTUATION COMMANDS OR PAYLOADS, AND FUNCTIONS AS A MACHINE-VERIFIABLE RECORD TO SUPPORT DOWNSTREAM POLICY ENFORCEMENT.

### Window Identifier and Cycle Indexing

EACH CONTROL CYCLE T IS ASSOCIATED WITH A WINDOW IDENTIFIER WID(T), DEFINED AS: WID(T):=(BOOT NONCE, MONOTONIC COUNTER), WHERE BOOT NONCE IS A BOOT-UNIQUE UNPREDICTABLE VALUE AND MONOTONIC COUNTER IS INCREMENTED PER ADMISSIBLE CYCLE. WID(T) PROVIDES ORDERING, REPLAY LINKAGE, AND ANTI-ROLLBACK PROTECTION FOR EVIDENCE RECORDS.

### Minimal Replay Record and Metrics-Integrity Binding

FOR EACH CYCLE T, THE SYSTEM MAY EMIT A REPLAY RECORD R<sub>></sub>(T) CONTAINING: WID(T); POLICY IDENTIFIERS; THE METRIC VECTOR; THE COMPUTED RESIDUAL Γ(T); LAMBDA(G) OUTCOME; TOKEN VALIDITY; FIRST_FAILING_GATE ENUMERATION; AND OPTIONAL EXPL_HASH. THIS RECORD IS HASH-LINKED TO THE PRIOR ERTUPLE. WHEN PERMIT IS GRANTED, Φ<sub>R</sub> MAY INCLUDE A DIGEST OF R<sub>Γ</sub>(T), BINDING THE OUTCOME TO A VERIFIABLE TRACE.

### Metric Evaluation Order and First-Fail Traceability

TO SUPPORT CONSISTENT REPLAY, METRICS ARE EVALUATED IN FIXED ORDER: (1) ICS; (2) PR<sub>LCB</sub>; (3) CI<sub>WIDTH</sub>; (4) ΔV; (5) C. IF ANY METRIC VIOLATES ITS ACCEPTANCE BAND, THE SYSTEM RECORDS THE FIRST_FAILING_GATE AND ABSTAINS. THIS ORDERING DEFINES A NON-COMPENSATORY ADMISSIBILITY PATH AND ENABLES TRACEABLE DENIAL REASONS IN REPLAY.

### Federated Token Extension and Ratification Signal

FEDERATED TOKENS MAY INCLUDE OPTIONAL FIELDS SUCH AS RATIFY SIG OR POLICY SCOPE ID TO SIGNAL RATIFIED PERMISSION SCOPE. A TOKEN SCHEMA MAY INCLUDE: TOKEN ID, VALID_FROM, VALID_TO, ISSUER_SIG, POLICY SCOPE ID, AND OPTIONAL RATIFY DIGEST. THESE EXTENSIONS SUPPORT INTER-JURISDICTIONAL PERMISSION MODELS AND ENFORCE ADDITIONAL EXTERNAL CONSTRAINTS.

### Sealed Storage Promotion and ST2 Admissibility

CERTAIN CYCLES MAY QUALIFY FOR IMMUTABLE STORAGE TIER (ST2) WHEN: LAMBDA(G)=1, THE TOKEN IS VALID, AND A SEALING CONDITION IS MET (E.G., PASS_RATIO≥0.995 OVER WINDOW W). ST2 RECORDS ARE HASH-LINKED BY MERKLE ROOT AT WINDOW BOUNDARIES AND SIGNED USING A SECURE ELEMENT. THE WRITE PATH IS APPEND-ONLY AND PROVIDES VERIFIABLE LINEAGE FOR ADMITTED WINDOWS.

### Deterministic Replay and Fail-Closed Invariant

REPLAY VERIFIERS MAY RE-EVALUATE ANY CYCLE BY RECOMPUTING METRICS, DERIVING T, AND APPLYING LAMBDA(G). IF LAMBDA(G) RECOMPUTED #RECORDED VALUE, THE CYCLE IS DEEMED UNVERIFIABLE. IN SUCH CASES, DOWNSTREAM ACTS ARE REJECTED, AND THE SYSTEM ENTERS FAIL-CLOSED STATE UNTIL RECONCILIATION OCCURS.

### ST3 Recording Tier and Temporal Retention

REJECTED OR ABSTAINED CYCLES, FIRST_FAILING_GATE HISTOGRAMS, SAFE_STATE TRANSITIONS, AND CRP EVENTS MAY BE LOGGED IN A NON-AUTHORITATIVE TIER (ST3). ST3 RECORDS ARE HASH-LINKED FOR TAMPER EVIDENCE. PROMOTION TO ST2 REQUIRES PASS_RATIO AND SEALING POLICIES TO BE MET.

### Embodiment Title

Real-Time National Formation with 200 Nodes—Proof-Before-Action Federation

### Overview

THIS EMBODIMENT DESCRIBES A WORKING SYSTEM WITH 200+ INDIVIDUAL NODES INTERCONNECTED UNDER THE REVERSE LAW. EACH NODE ENFORCES SAME-CYCLE EVIDENCE COMMIT AND TOKEN VALIDATION BEFORE EXTERNALIZATION. WINDOW SUMMARIES FLOW TO A FEDERATION AUTHORITY THAT COMPUTES FC AND PROPAGATES REVOCATION WITH BOUNDED LATENCY.

### Node Distribution (Exemplary)

GOVERNMENT AND FEDERAL AGENCIES: 40 NODES (CERTIFICATION, REGULATORY MONITORING)
FINTECH EXECUTION AND RISK NODES: 80 NODES (ROUTERS, QUOTE/RISK, CLEARING GATEWAYS)
HEALTHCARE TRIAGE AND DOSING: 60 NODES (HOSPITAL HUBS, LAB/PHARMACY INTERFACES)
PLATFORM/UTILITY AND TELEMETRY: 20 NODES (TIME, CRYPTO, LOG REPLICATION)

TOTAL: 200 NODES

### Construction

(A) TIME: PTP/GPTP GRANDMASTER WITH REDUNDANT GRANDMASTERS; POLICY-BOUND SKEW TARGET<=1 MS; MONOTONIC COUNTERS AT EACH NODE.
(B) GOVERNOR: REAL-TIME THREAD 50-100 HZ, WCET BUDGETED AT <=100 MS P95; HOT-PATH CRYPTO (HASH+SIGN+WAL)<=5 MS P99 USING SECURE ELEMENT OR ACCELERATOR.
(C) LEDGER: APPEND-ONLY HASH CHAIN PER CYCLE; MERKLE ROOT FINALIZATION EACH WINDOW; ROOT_AGE<=2 WINDOWS; TAMPER GAP=0.
(D) FEDERATION: HIGH COMMISSION CLUSTER (N>=3) WITH QUORUM; CANONICAL WINDOW SUMMARY SCHEMA (VERSIONED); TOKEN ISSUANCE AND CRL SERVICE; REVOCATION BROADCAST OVER PRIMARY AND SECONDARY CHANNELS.
(E) HUMAN OVERSIGHT: TAU INTERFACE WITH CONSENT_FLAG, OVERRIDE CODE, TS_TAU; OPTIONAL DELEGATED-TRUST TIERS FOR LOW-RISK CASES.

### Operation

STEP 1 (INGEST): NODES INGEST INPUTS; VERIFY POLICY HASH; UPDATE LOCAL STATE.
STEP 2 (METRICS): COMPUTE C, ICS, PR_ONLINE, PR_LCB, CI_WIDTH, DELTA_V; OPTIONAL JERK.
STEP 3 (GATE): EVALUATE GAMMA=MAX {0.90−ICS, 0.80−PR_LCB, CI_WIDTH−0.03, DELTA_V, PRE_OK FAILURES, COMMIT_FAIL, ATTESTATION_FAIL, C_STAR-C}.
STEP 4 (EVIDENCE): IF GAMMA=0, WRITE SIGNED ERTUPLE IN SAME CYCLE; ELSE SAFE_STATE AND FREEZE UPDATES; EMIT TAU NOTICE AS NEEDED.
STEP 5 (PERMISSION): VERIFY AUTHORIZATION TOKEN; IF VALID AND NOT REVOKED, PERMIT EXTERNALIZATION; ELSE DENY.
STEP 6 (WINDOW): EVERY W CYCLES (E.G., W=100), BUILD WINDOW SUMMARY WITH PASS_RATIO, FIRST_FAILING_GATE_HISTOGRAM, TIMING AND REVOCATION ACKS; SEND TO HIGH COMMISSION; RECEIVE POLICY UPDATES AT WINDOW BOUNDARIES.

### Quantified Results (Formation Totals; Example Run)

TABLE 2
FORMATION METRICS

| \| METRIC | \| TARGET | \| RESULT | \| |
|---|---|---|---|
| STATUS \| | | | |
| \|------------------------\|----------\|------------------------\|-- | | | |
| ------\| | | | |
| \| PASS_RATIO | \| >=0.995 | \| 0.996 | \| |
| PASS \| | | | |
| \| FC (FLEET CONSISTENCY) | \| >=0.95 | \| 0.955 +/− 0.006 | \| |
| PASS \| | | | |
| \| ICS | \| >=0.90 | \| 0.931 +/− 0.019 | \| |
| PASS \| | | | |
| \| PR_LCB | \| >=0.80 | \| 0.832 +/− 0.012 | \| |
| PASS \| | | | |
| \| CI_WIDTH | \| <=0.03 | \| 0.0259 +/− 0.0038 | \| |
| PASS \| | | | |
| \| DELTA_V | \| <=0 | \| −0.029 +/− 0.010 | \| |
| PASS \| | | | |
| \| REVOCATION P95 | \| <=30 S | \| 24.7 S | \| |
| PASS \| | | | |
| \| AUDIT REPLAY LATENCY | \| <=0.10 S | \| 0.07 S | \| |
| PASS \| | | | |
| \| ENERGY/DECISION | \| <=1.0 J | \| 0.68 J | \| |

PASS |

### Sector Breakdown (Example)

TABLE 3
METRICS BY SECTOR

| | | | | |
|---|---|---|---|---|
| \| SECTOR | \| NODES | \| PASS_RATIO | \| FC_LOCAL | \| ICS \| PR_LCB \| |

| | | | |
|---|---|---|---|
| CI_WIDTH | \| DELTA_V | \| REVOC P95 | \| |

|------------|-------|------------|----------|-------|--------|-
---------|----------|-----------|

| \| GOV/FED | \| 40 | \| 0.997 | \| 0.958 | \| 0.936 \| 0.835 \| |
|---|---|---|---|---|
| 0.0254 | \| −0.031 | \| 25.2 S | \| | |
| \| FINTECH | \| 80 | \| 0.996 | \| 0.954 | \| 0.928 \| 0.829 \| |
| 0.0262 | \| −0.028 | \| 23.9 S | \| | |
| \| HEALTHCARE | \| 60 | \| 0.996 | \| 0.956 | \| 0.933 \| 0.834 \| |
| 0.0257 | \| −0.030 | \| 24.8 S | \| | |
| \| PLATFORM | \| 20 | \| 0.998 | \| 0.960 | \| 0.940 \| 0.838 \| |

| | | | |
|---|---|---|---|
| 0.0249 | \| −0.032 | \| 24.1 S | \| |

### Stress Tests (Selected)

NOISE INJECTION (GAUSSIAN, SNR 10-20 DB): PASS_RATIO>=0.995; NO UNSAFE EXTERNALIZATION.
LATENCY FAULTS (+30 MS BURSTS): BREAKER OPEN RATE<=0.8 PERCENT WINDOWS; RE-ADMIT Q=3.
CRYPTO FAILOVER (KEY ROTATION DURING LOAD): TAMPER GAP=0; REVOC ACKS LOGGED.
QP INFEASIBILITY (IF USED): FALLBACK CONTROLLER ENGAGED<0.1 PERCENT CYCLES; DELTA_V<=0.

### Audit and Replay

DETERMINISTIC REPLAY WITH +/−5 PERCENT TOLERANCE ACHIEVED ON RANDOM SAMPLE WINDOWS ACROSS ALL SECTORS. INCLUSION PROOFS VERIFIED; TIMING AND FIRST_FAILING_GATE HISTOGRAMS MATCHED RECORDED SUMMARIES.

### EMBODIMENT SUMMARY

THE 200+-NODE FORMATION OPERATED WITH ZERO UNSAFE ACTUATIONS, BOUNDED REVOCATION LATENCY, AND CONSISTENT FLEET METRICS. CLOSED FEEDBACK LOOPS HELD ADAPTATION WITHIN POLICY BOUNDS, AND ALL EXTERNALIZATIONS WERE COUPLED TO SAME-CYCLE, METRICS-ONLY EVIDENCE.

### Equal-Weight Lawful Gate Policy (Normative)

ALL ACTIVE ACCEPTANCE BANDS ARE WEIGHTED EQUALLY IN THE PERMIT PREDICATE. NO WEIGHTED AVERAGE MAY TRADE SAFETY FOR ACCURACY OR ETHICS. THE ACCEPTANCE VECTOR IS: G=[ICS>=0.90, DELTA_V<=0, PR_LCB>=0.80, CI_WIDTH<=0.03, C>=C_STAR].

THE CONJUNCTIVE PREDICATE IS:

LAMBDA(G)=1 ONLY IF EVERY ELEMENT IN G PASSES; OTHERWISE LAMBDA(G)=0.

DEFINE GAMMA=NOT LAMBDA(G). IF GAMMA=1 IN ANY CYCLE, THE SYSTEM SHALL ENTER SAFE_STATE (DELTA THETA:=0; U:=U SAFE), RECORD AN ERTUPLE IN THE SAME CYCLE, AND REMAIN IN SAFE_STATE UNTIL RE-ADMISSION CRITERIA ARE MET. THIS POLICY FEEDS THE CONCURRENCE GATE (CG).

### Final Integrated Version (VIV) Loop

THE VIV LOOP INTEGRATES: PR BUDGET X (ONLINE PR WITH K<=32, OFFLINE CALIBRATION WINDOWS), EPSILON (I_PHI, PR_LCB) WITH BOUNDS/HYSTERESIS/PROJECTION, SHOCK-TAIL (BREAKER LOGIC), H LOOP AT 50-100 HZ, BIG-CONCERN->HUMAN REVIEW PATH (OPTIONAL), HARM VS BENIGN DISCOMFORT BUDGETS, PTP SENTINELS, AND CYCLE QUANTIFIERS. REQUIRED QUANTIFIERS PER WINDOW: LATENCY P95, LATENCY P99, JITTER, ERT<=5, TOKEN TTL, FIRST_FAILING_GATE, PASS_RATIO, FC_LOCAL, BROADCAST_COMPLETENESS. FAIRNESS (E.G., GROUP DISPARITY INDEX<=1.10) AND TRANSPARENCY HOOKS (EXPL_HASH) ARE INCLUDED AS OPTIONAL BANDS THAT CANNOT WEAKEN CORE SAFETY.

### Revocation Burst Drill Log (Annex H Reference)

THE FEDERATION SHALL CONDUCT A “REVOCATION BURST DRILL” WITH >=7 NODES INDEPENDENTLY REVOCATED WITHIN A SINGLE WINDOW. REQUIRED RESULT: P95 PROPAGATION<=30 S, WITH WINDOW SUMMARY FIELDS INCLUDING {REVOCATION EVENT ID, NODE LIST, P FIRST ACK, P95 PROPAGATION, CHANNELS USED, SIGNATURE}. DRILL FAILURES COUNT AS WINDOW VIOLATIONS AND REQUIRE RE-ADMISSION POLICY BEFORE NORMAL OPERATION RESUMES.

### Canonical Window Summary V1 (Figure Spec Caption)

WINDOW_SUMMARY V1 FIELDS AND TYPES (MINIMUM SET):
NODE_ID (STRING), WINDOW_ID (UINT64), TS_START/TS_END (PTP INT64 NS)
PASS_RATIO (FLOAT32), FC_LOCAL (FLOAT32)
FIRST_FAILING_GATE_HISTO (MAP<STRING, UINT32>)
PTP_SKEW_STATS {P50, P95, P99} (FLOAT32, MS)
CYCLE_LATENCY_STATS {P50, P95, P99} (FLOAT32, MS)
REVOCATION_ACK_COUNT (UINT32), REVOCATION EVENTS (ARRAY<STRUCT>)
BROADCAST_COMPLETENESS (FLOAT32, 0 . . . 1)
OPTIONAL: CAUSAL LATENCY P50/P95 (FLOAT32, MS), EXPL_HASH (BYTES32)
ROOT_AGE (UINT32 WINDOWS), MERKLE LAG P95 (FLOAT32, MS)
SCHEMA_VERSION (UINT16), SIGNATURE (BYTES) BACKWARD COMPATIBILITY: FIELDS MAY BE EXTENDED; SCHEMA_VERSION REQUIRED.

### Worked Numerical Example (Annex B-X Pointer)

EXAMPLE: 50-CYCLE TRACE WITH POLICY BANDS ICS>=0.90, PR_LCB>=0.80, CI_WIDTH<=0.03, DELTA_V<=0, C>=C_STAR=0.85. SUMMARY:
CYCLES PASSING ALL BANDS: 46/50
ABSTAIN (ROBUSTNESS BAND FAIL): 3/50
SAFE_STATE (DELTA_V>0 ONCE): 1/50
RESULTING PASS_RATIO: 0.920 AT CYCLE GRANULARITY; WINDOW ADMISSION REQUIRES RE-ADMIT Q=3 (AT NODE-LEVEL, PASS_RATIO COMPUTED OVER WINDOWS; THIS EXAMPLE ILLUSTRATES CYCLE OUTCOMES).

### Sample of First 5 Cycles:

| CYCLE | ICS | PR_LCB | CI_WIDTH | DELTA_V | C | GAMMA | LAMBDA (G) |
| ---------- | ----- | -----------| ----------------| --------------| -- | ------------ | ------------------ |
| 1 | 0.93 | 0.82 | 0.028 | −0.004 | 0.90 | 0 | 1 |
| 2 | 0.91 | 0.79 | 0.029 | −0.003 | 0.88 | 1 | 0 (ABSTAIN) |
| 3 | 0.95 | 0.85 | 0.031 | −0.002 | 0.89 | 1 | 0 (ABSTAIN: CI) |
| 4 | 0.92 | 0.83 | 0.027 | −0.006 | 0.91 | 0 | 1 |
| 5 | 0.94 | 0.81 | 0.029 | +0.001 | 0.92 | 1 | 0 (SAFE_STATE: DELTA_V>0) |

AFTER THE SAFE_STATE EVENT (CYCLE 5), DELTA THETA:=0; CIRCUIT-BREAKER COUNTS 1 VIOLATION.

RE-ADMISSION REQUIRES Q CLEAN WINDOWS PER POLICY. THE ERTUPLE FOR EACH CYCLE INCLUDES {POLICY_VER, MODEL_ID, ICS, PR_LCB, CI_WIDTH, DELTA_V, C, TS PTP, FIRST_FAILING_GATE, HASH, SIGNATURE}. DETERMINISTIC REPLAY MATCHES +/−5 PERCENT TOLERANCE.

### LIST OF FIGURES

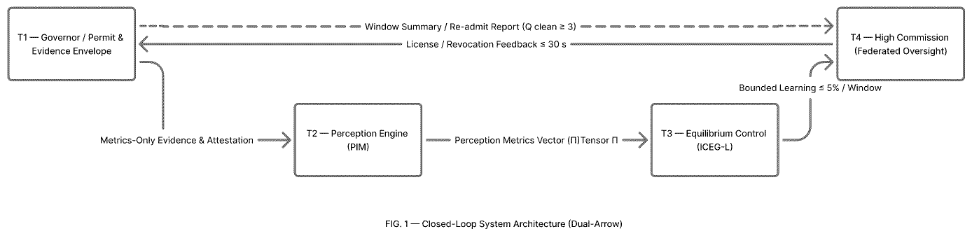

FIG. 1 ILLUSTRATES A CLOSED-LOOP DETERMINISTIC RUNTIME GOVERNANCE ARCHITECTURE INCLUDING A GOVERNOR OR CONCURRENCE GATE, A PERCEPTION ENGINE, AN EQUILIBRIUM CONTROL MODULE, AND A FEDERATED OVERSIGHT COMPONENT WITH BIDIRECTIONAL FEEDBACK PATHS.

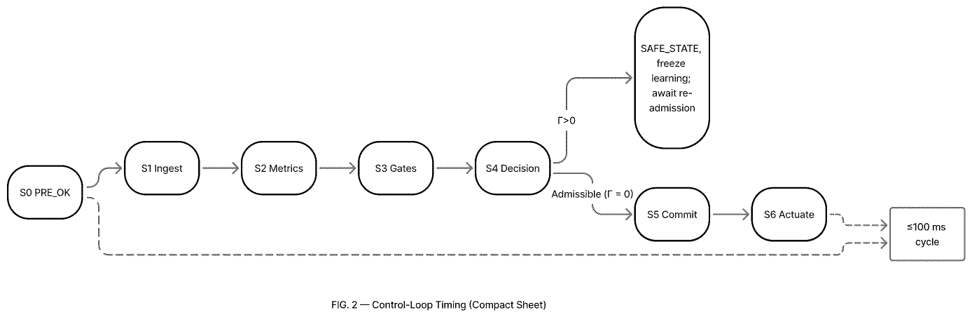

FIG. 2 ILLUSTRATES CONTROL-LOOP TIMING ACROSS DISCRETE EVALUATION WINDOWS, INCLUDING INGESTION, METRIC COMPUTATION, GATING, DECISION, COMMITMENT, ACTUATION, AND TRANSITION TO A SAFE_STATE WITHIN A BOUNDED CYCLE TIME.

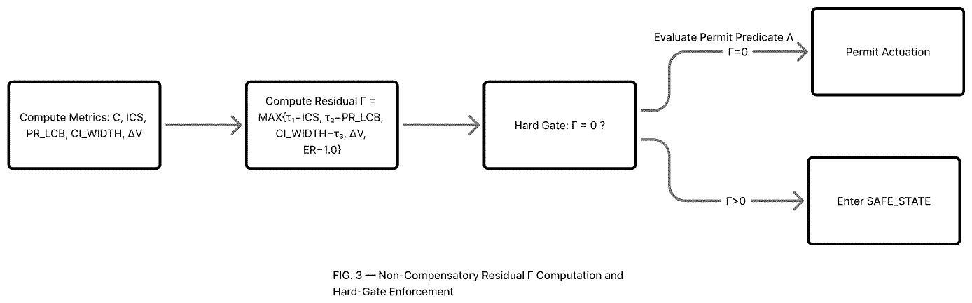

FIG. 3 ILLUSTRATES COMPUTATION OF A NON-COMPENSATORY RESIDUAL COHERENCE SCALAR T FROM MULTIPLE METRIC THRESHOLDS AND HARD-GATE ENFORCEMENT OF PERMIT-TO-ACT OR ENTRY INTO A SAFE_STATE BASED ON THE COMPUTED RESIDUAL.

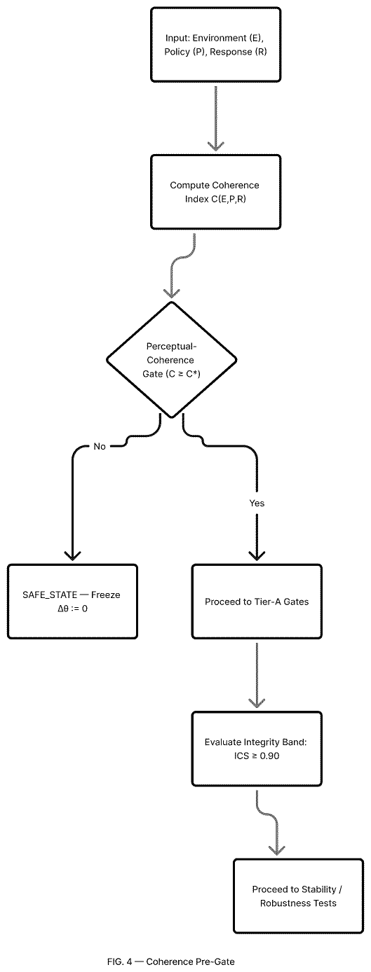

FIG. 4 ILLUSTRATES A COHERENCE PRE-GATE IN WHICH AN ENVIRONMENT-POLICY-RESPONSE COHERENCE INDEX IS EVALUATED PRIOR TO INTEGRITY, STABILITY, AND ROBUSTNESS ASSESSMENTS, WITH TRANSITION TO A SAFE STATE UPON FAILURE.

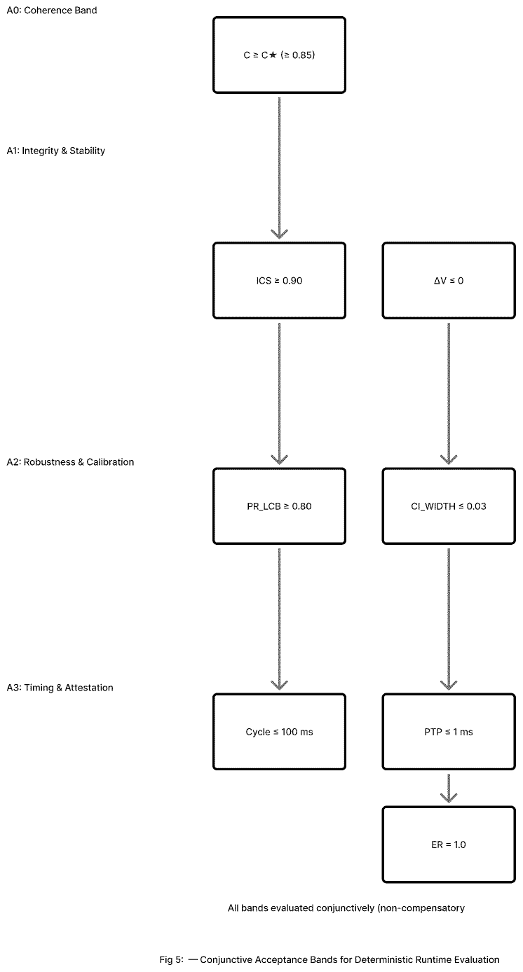

FIG. 5 ILLUSTRATES CONJUNCTIVE ACCEPTANCE BANDS AND METRIC THRESHOLDS EVALUATED IN A FIXED ORDER, INCLUDING COHERENCE, INTEGRITY, STABILITY, ROBUSTNESS OR CALIBRATION, TIMING, AND ATTESTATION CONSTRAINTS.

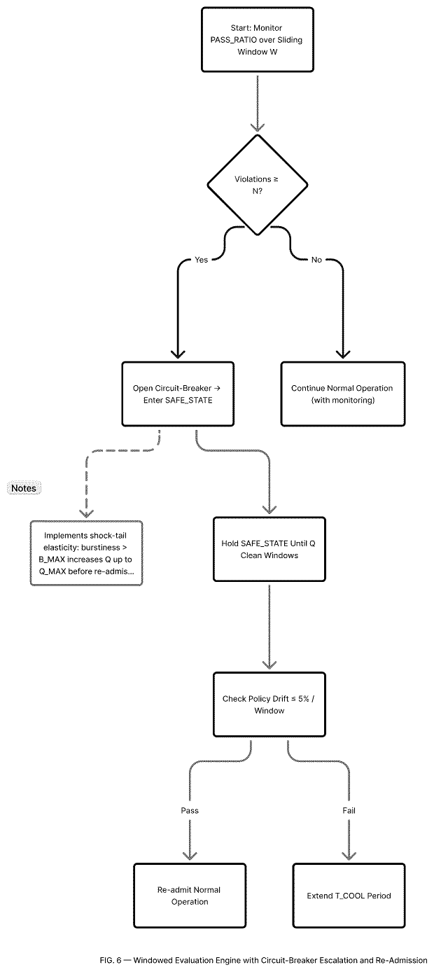

FIG. 6 ILLUSTRATES A WINDOWED EVALUATION ENGINE WITH CIRCUIT-BREAKER ESCALATION, INCLUDING SLIDING-WINDOW PASS-RATIO MONITORING, ENTRY INTO A SAFE_STATE UPON VIOLATIONS, AND CONDITIONAL RE-ADMISSION AFTER CLEAN WINDOWS.

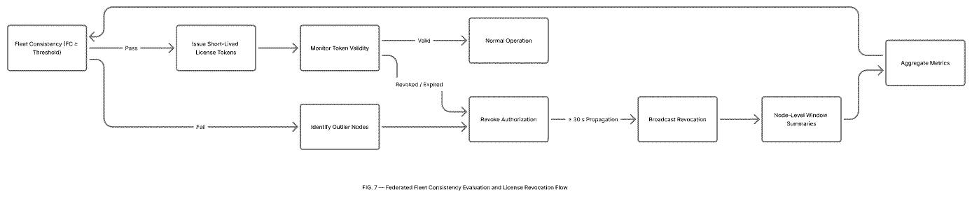

FIG. 7 ILLUSTRATES FEDERATED FLEET CONSISTENCY EVALUATION AND LICENSE REVOCATION FLOW, INCLUDING AGGREGATION OF NODE-LEVEL WINDOW SUMMARIES, ISSUANCE OF SHORT-LIVED AUTHORIZATION TOKENS, MONITORING OF TOKEN VALIDITY, IDENTIFICATION OF OUTLIER NODES, AND BOUNDED-TIME REVOCATION PROPAGATION.

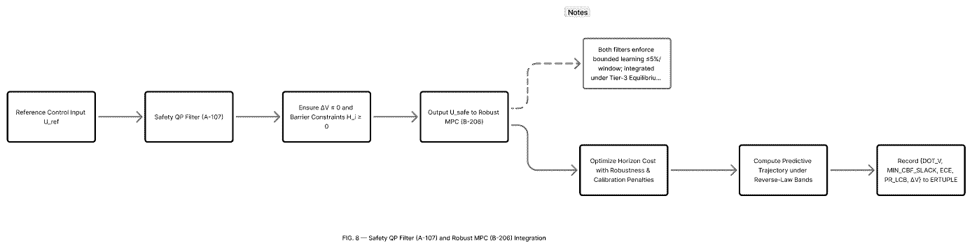

FIG. 8 ILLUSTRATES INTEGRATION OF A SAFETY-CONSTRAINED OPTIMIZATION FILTER WITH A ROBUST MODEL-PREDICTIVE CONTROL MODULE, INCLUDING BOUNDED LEARNING, STABILITY ENFORCEMENT, AND EVIDENCE RECORDING.

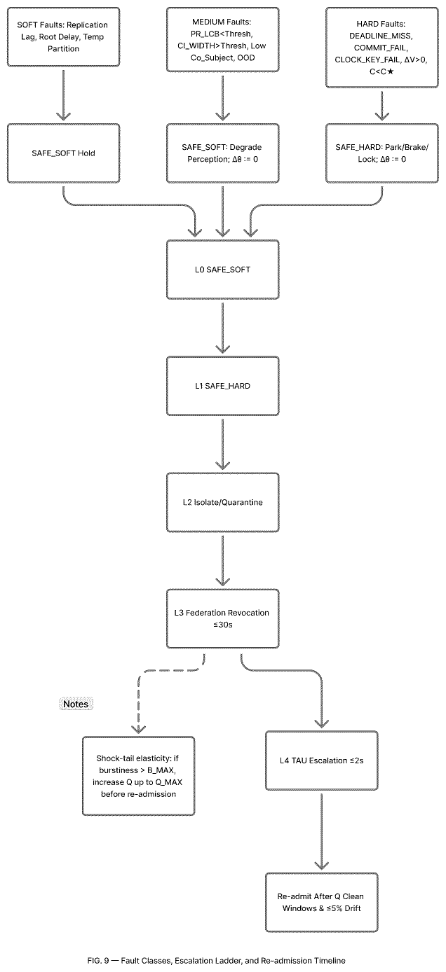

FIG. 9 ILLUSTRATES FAULT CLASSES, AN ESCALATION LADDER, AND RE-ADMISSION CONDITIONS, INCLUDING SOFT, MEDIUM, AND HARD FAULT HANDLING, ISOLATION OR QUARANTINE, FEDERATION-LEVEL REVOCATION, AND RECOVERY CRITERIA.

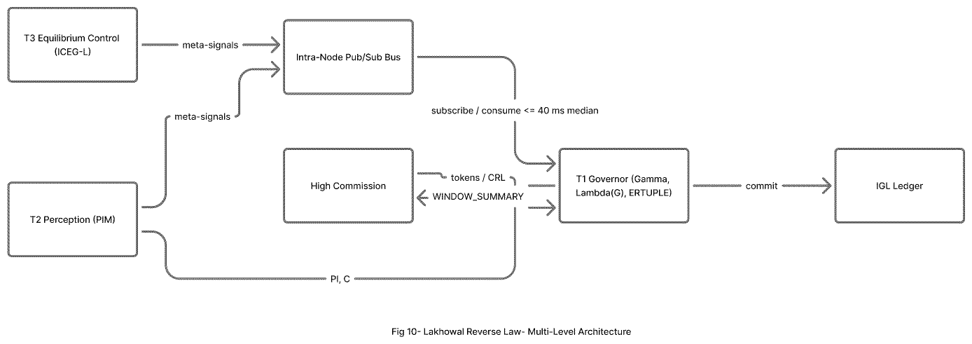

FIG. 10 ILLUSTRATES A MULTI-LEVEL RUNTIME ARCHITECTURE WITH TIERS AND COMMUNICATION BUSES, INCLUDING INTRA-NODE PUB-SUB SIGNALING, GOVERNANCE EVALUATION, FEDERATED OVERSIGHT COMMUNICATION, AND AUDIT COMMITMENTS.

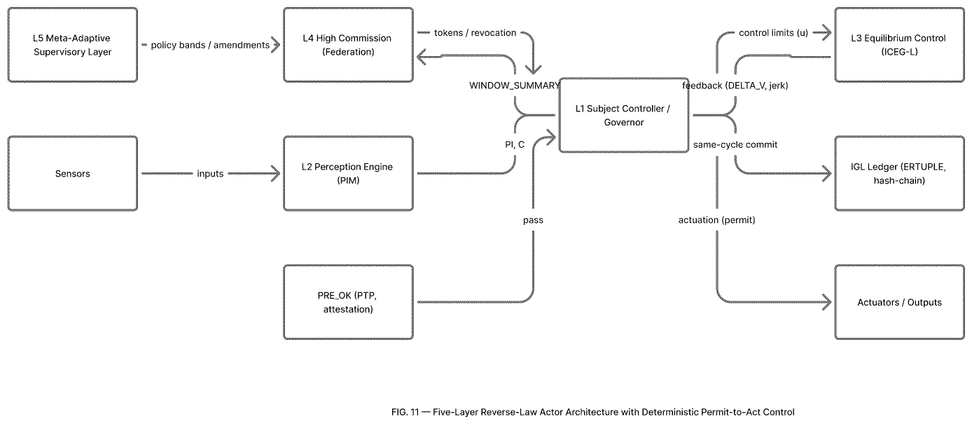

FIG. 11 ILLUSTRATES A FIVE-LAYER ACTOR ARCHITECTURE INCLUDING SENSING, PERCEPTION, A SUBJECT CONTROLLER OR GOVERNOR, EQUILIBRIUM CONTROL, AND FEDERATED SUPERVISORY LAYERS WITH DETERMINISTIC PERMIT-TO-ACT ENFORCEMENT.

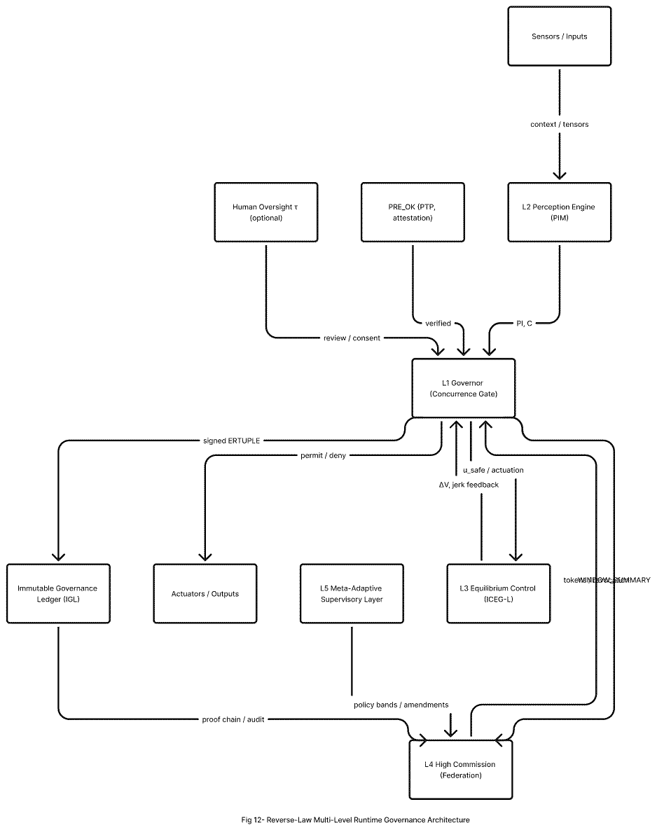

FIG. 12 ILLUSTRATES A MULTI-LEVEL RUNTIME GOVERNANCE ARCHITECTURE SHOWING INTERACTIONS AMONG PERCEPTION, CONTROL, GOVERNANCE, OVERSIGHT, ACTUATION, LOGGING, AND AN OPTIONAL HUMAN OVERSIGHT INTERFACE.

1. (METHOD—PROOF-BEFORE-ACTION GOVERNOR) A COMPUTER-IMPLEMENTED METHOD FOR RUNTIME GOVERNANCE OF AN AUTONOMOUS OR SEMI-AUTONOMOUS SYSTEM, EXECUTED BY A DETERMINISTIC CONTROL PROCESSOR OR SECURE-ELEMENT CRYPTOGRAPHIC MODULE OPERATING AT A CONTROL-CYCLE LATENCY OF ≤100 MILLISECONDS, THE METHOD COMPRISING:
(A) OBTAINING, FOR EACH CONTROL CYCLE, MEASURABLE SAFETY METRICS INCLUDING AT LEAST:
(I) A COHERENCE INDEX (C) INDICATING PERCEPTUAL ALIGNMENT OF ENVIRONMENT, POLICY, AND RESPONSE;
(II) AN INTEGRITY-CONFIDENCE SCORE (ICS);
(III) A ROBUSTNESS LOWER BOUND (PR_LCB) AND AN ASSOCIATED CONFIDENCE-INTERVAL WIDTH (CI_WIDTH);
(IV) A STABILITY RESIDUAL (DELTA_V); AND
(V) TIMING AND ATTESTATION INDICATORS DERIVED FROM A HARDWARE CLOCK OR PRECISION-TIME PROTOCOL;
(B) COMPUTING, WITHIN SAID PROCESSOR, A NON-COMPENSATORY RESIDUAL GAMMA DEFINED AS A MAXIMUM ACROSS DEVIATIONS OF THE SAFETY METRICS FROM PREDEFINED ACCEPTANCE BANDS AND AT LEAST ONE HARDWARE-VERIFIED HARD-STOP PREDICATE, SUCH THAT
GAMMA=MAX{T1-ICS,T2-PR_LCB,CI_WIDTH-T3,DELTA_V,ER-1.0,DEADLINE_MISS,COMMIT_FAIL,CLOCK_KEY_FAIL,(C_STAR-C)};
(C) EVALUATING A PERMIT PREDICATE LAMBDA(G) SATISFIED ONLY WHEN GAMMA=0;
(D) COMMITTING, WITHIN THE SAME CONTROL-CYCLE DEADLINE, A SIGNED, METRICS-ONLY EVIDENCE RECORD TO A HARDWARE-ANCHORED APPEND-ONLY STORE IMPLEMENTED BY THE SECURE ELEMENT OR CRYPTOGRAPHIC MODULE; AND
(E) PERMITTING ACTUATION ONLY WHEN (I) LAMBDA(G)=1 AND (II) THE COMMIT OF STEP (D) SUCCEEDS, THEREBY ESTABLISHING A CAUSAL ORDER OF PROOF→PERMISSION→ACTUATION;
(F) SETTING A DECISION FLAG ABSTAIN AND INHIBITING EXTERNALIZATION AND LEARNING UPDATES (DELTA THETA:=0) WHEN UNCERTAINTY OR COUNTERFACTUAL-ACCURACY CRITERIA FAIL; AND
(G) ENTERING A SAFE_STATE WHENEVER ANY HARD-STOP PREDICATE IS DETECTED, THE EVIDENCE COMMIT FAILS, OR ATTESTATION INTEGRITY IS VIOLATED.

2. (SYSTEM—MACHINE-ENFORCEABLE RUNTIME LAW) A SYSTEM COMPRISING:
(A) ONE OR MORE PROCESSORS INCLUDING AT LEAST ONE HARDWARE CRYPTOGRAPHIC MODULE OR DETERMINISTIC CONTROL UNIT CONFIGURED TO EXECUTE CONTROL CYCLES AT ≤100 MILLISECONDS;
(B) MEMORY STORING INSTRUCTIONS THAT CAUSE THE PROCESSORS TO:
(I) COMPUTE THE SAFETY METRICS AND RESIDUAL GAMMA OF claim 1;
(II) EVALUATE LAMBDA(G);
(III) WRITE A SIGNED, METRICS-ONLY EVIDENCE RECORD WITHIN THE SAME CONTROL CYCLE; AND
(IV) ISSUE ACTUATION SIGNALS ONLY WHEN BOTH CONDITIONS (GAMMA=0) AND (SUCCESSFUL SAME-CYCLE COMMIT) ARE SATISFIED; AND
(C) A CIRCUIT-BREAKER CONTROLLER THAT ENFORCES A DEFAULT-DENY SAFE_STATE AND REQUIRES Q CLEAN CYCLES FOR RE-ADMISSION.

3. (FEDERATED CERTIFICATION—HIGH COMMISSION) A FEDERATED GOVERNANCE SYSTEM COMPRISING:
(A) A VERIFICATION PIPELINE CONFIGURED TO RECEIVE SEQUENCE-ATTESTED WINDOW SUMMARIES DERIVED FROM METRICS-ONLY EVIDENCE COMMITTED UNDER claim 1;
(B) A CONSISTENCY ENGINE THAT COMPUTES FLEET-LEVEL CONSISTENCY (FC) AND FLEET-LEVEL COHERENCE (FC C) FROM SAID SUMMARIES; AND
(C) A TOKEN SERVICE IMPLEMENTED ON DETERMINISTIC OR SECURE-ELEMENT HARDWARE THAT ISSUES TIME-BOUNDED AUTHORIZATION TOKENS AND REVOKES THEM WITHIN A BOUNDED PROPAGATION LATENCY, WHEREIN EACH NODE ENFORCES A STRICT-AND PERMISSION REQUIRING BOTH (GAMMA=0) AND POSSESSION OF A VALID, NON-REVOKED TOKEN PRIOR TO ACTUATION.
THE METHOD OF claim 1, WHEREIN THE SAFETY METRICS ARE MAINTAINED WITHIN ACCEPTANCE BANDS CONFIGURABLE BY POLICY PARAMETERS DEFINED BY A RUNTIME RISK-MANAGEMENT POLICY EXECUTABLE BY THE SAME PROCESSOR.
THE METHOD OF claim 1, WHEREIN THE EVIDENCE RECORD EXCLUDES MODEL INPUTS, MODEL OUTPUTS, AND PERSONALLY IDENTIFIABLE INFORMATION, AND COMPRISES FIELDS SUFFICIENT FOR DETERMINISTIC REPLAY WITHIN ±5 PERCENT ACCURACY.
THE METHOD OF claim 1, WHEREIN PERMISSION IS ISSUED ONLY UPON SUCCESSFUL SAME-CYCLE VERIFICATION OF ALL SAFETY METRICS AND EVIDENCE-COMMIT INTEGRITY, DISTINGUISHING OVER POST-ACTION AUDIT SYSTEMS.
THE METHOD OF claim 1, WHEREIN THE COHERENCE INDEX (C) IS EVALUATED AS A STAGE-O PRE-GATE AND, WHEN C<C_STAR, THE CONTROLLER TRANSITIONS DIRECTLY TO THE SAFE_STATE AND FREEZES LEARNING PARAMETERS.
THE METHOD OF claim 1, WHEREIN A HUMAN-OVERSIGHT INTERFACE GENERATES A DIGITAL PERMISSION BIT PROCESSED BY THE SAME CONTROL GOVERNOR, THE BIT BEING TREATED AS AN EVENT SIGNAL WITHIN THE SAME TIMING DOMAIN.
THE SYSTEM OF claim 2, WHEREIN TIMING AND ATTESTATION ARE PERFORMED BY A PRECISION-TIME-PROTOCOL HARDWARE CLOCK OR EQUIVALENT SECURE-ELEMENT OSCILLATOR, AND FAILURES THEREOF SET GAMMA>0 AND TRIGGER THE SAFE_STATE.
THE METHOD OF claim 1, FURTHER COMPRISING MAINTAINING A SLIDING-WINDOW PASS_RATIO AND OPERATING A CIRCUIT-BREAKER THAT HOLDS THE SAFE_STATE UNTIL A RE-ADMISSION CRITERION OF Q CLEAN CYCLES IS MET, WHEREIN Q IS ADAPTIVELY INCREASED UNDER BURST CONDITIONS (SHOCK-TAIL ELASTICITY).
THE METHOD OF claim 1, WHEREIN LEARNING UPDATES ARE BOUNDED TO ≤5 PERCENT PER WINDOW AND JERK IS LIMITED BY A JERK CONSTANT J_LIM, THE BOUNDS BEING ENFORCED BY THE DETERMINISTIC CONTROL PROCESSOR.
THE METHOD OF claim 1, IMPLEMENTED IN AUTONOMOUS CONTROL OR FEDERATED AI GOVERNANCE SYSTEMS, THE DOMAINS BEING EXEMPLARY AND NON-LIMITING.
THE METHOD OF claim 1, WHEREIN THE SYSTEM OPERATES IN ASYNCHRONOUS OR SOFT-REAL-TIME MODES WITH PREDICTIVE COMMIT CACHING, THE EVIDENCE RECORD BEING PRE-STAGED FOR THE NEXT CYCLE TO PRESERVE EFFECTIVE SAME-CYCLE SEMANTICS.
THE METHOD OF claim 1, WHEREIN NUMERIC THRESHOLDS T1-T3 AND C_STAR ARE POLICY-DEFINED VARIABLES STORED IN A CONFIGURATION REGISTER ACCESSIBLE TO AUTHORIZED FIRMWARE UPDATES.
THE METHOD OF claim 1, WHEREIN A RISK-MANAGEMENT POLICY EXECUTABLE AT RUNTIME DYNAMICALLY ADJUSTS THE ACCEPTANCE BANDS BASED ON OBSERVED DRIFT WITHOUT REFERENCE TO ANY EXTERNAL STANDARD.
THE METHOD OF claim 1, WHEREIN REVOCATION OF AUTHORIZATION TOKENS UNDER claim 3 PROPAGATES TO ALL NODES WITHIN A BOUNDED PERCENTILE LATENCY P95≤30 SECONDS, NODES REFUSING ACTUATION UPON TOKEN EXPIRY OR REVOCATION NOTICE.
THE METHOD OF claim 1, WHEREIN THE FEDERATED CERTIFICATION OF claim 3. SUPPORTS AN INSPECTOR INTERFACE PROVIDING READ-ONLY METRIC HEADERS SAMPLED ≤5 PERCENT WITHOUT EXPORTING CONTENT OR PII.
THE METHOD OF claim 1, WHEREIN THE GOVERNED SYSTEM FURTHER COMPRISES A HARDWARE-ANCHORED WORLD-MODEL ESTIMATING COUNTERFACTUAL ACCURACY, AND THE CONTROLLER SETS DECISION_FLAG=ABSTAIN WHEN THE ESTIMATED ACCURACY FALLS BELOW A POLICY THRESHOLD.
THE METHOD OF claim 1, WHEREIN FALLBACK OPERATION EMPLOYS PREDICTIVE COMMIT CACHING ENABLING CONTINUITY IN ASYNCHRONOUS ENVIRONMENTS WHILE RETAINING PROOF-BEFORE-ACTION CAUSALITY. A NON-TRANSITORY COMPUTER-READABLE MEDIUM STORING INSTRUCTIONS THAT, WHEN EXECUTED BY ONE OR MORE PROCESSORS INCLUDING AT LEAST ONE DETERMINISTIC OR SECURE-ELEMENT PROCESSOR, CAUSE PERFORMANCE OF THE METHOD OF ANY OF claims 1-19.
